(19) United States
(12) Patent Application Publication
(10) Pub. No.: US 2009/0086316 A1
(43) Pub. Date: Apr. 2, 2009

(54) ENVIRONMENT MAINTAINING APPARATUS FOR MICROSCOPE AND MICROSCOPE

(75) Inventor: Takashi KAWAHITO, Fusisawa City (JP)

Correspondence Address: MILES & STOCKBRIDGE PC, 1751 PINNACLE DRIVE, SUITE 500, MCLEAN, VA, 22102-3833, US

(73) Assignee: NIKON CORPORATION

(21) Appl. No.: 12/328,354

(22) Filed: Dec. 4, 2008

Related U.S. Application Data
(63) Continuation of application No. PCT/JP2007/063415, filed on Jun. 28, 2007.

(30) Foreign Application Priority Data
Jun. 30, 2006 (JP) 2006-181897

(51) Int. Cl. G02B 21/26

(52) U.S. Cl. 359/395; 359/392

(57) ABSTRACT

Providing a space-and-energy-saving environment maintaining apparatus for a microscope. A first chamber 2 forms an enclosed space and houses a stage 3 that supports a specimen 23, an objective lens 5, 105 that changes divergent light from the specimen 23 on the stage 3 into parallel light, and a focusing apparatus 4 attached to the stage 3 allowing the objective lens 5, 105 to move along the direction of its optical axis. A plane parallel glass plate 121 is provided on the first chamber 2 to transmit the parallel light to the outside.

### TECHNICAL FIELD

The present invention relates to an environment maintaining apparatus for use in a microscope for maintaining the environment around a specimen observed through the microscope, and to a microscope equipped with the same.

### BACKGROUND ART

As a prior art, an inspection apparatus described in Japanese Patent Application Laid-Open No. 2004-70307 has been known. This inspection apparatus is known as an inspection apparatus that is equipped with a main body of the apparatus, an inverted microscope and a temperature control apparatus.

In this inspection apparatus, the inverted microscope and the temperature control apparatus are housed in the main body of the apparatus.

In the above described inspection apparatus, since the inverted microscope and the temperature control apparatus are housed in the main body of the apparatus, there are problems that the size of the inspection apparatus is large, and the amount of energy consumed in maintaining the temperature in the interior of the main body of the apparatus at a specific temperature is large.

### DISCLOSURE OF THE INVENTION

The present invention has been made in view of the above described problems, and has as an object to provide an environment maintaining apparatus for use with a microscope and a microscope that enables space saving and energy saving.

To achieve the above object, according to a first aspect of the present invention, there is provided an environment maintaining apparatus for microscope characterized by comprising a stage that supports a specimen, an objective lens that changes light from the specimen on said stage into parallel light, moving means attached to said stage for allowing said objective lens to move along the direction of its optical axis, a chamber that houses said stage, said objective lens and said moving means to maintain environment, and a transmissive portion provided on said chamber to transmit said parallel light to the exterior.

In the first aspect of the present invention, it is preferred that the apparatus be provided with a specimen case placed on said stage to store said specimen and a specimen case transmissive portion provided on the specimen case to transmit light from said specimen.

In the first aspect of the present invention, it is also preferred that the apparatus be provided with a temperature control apparatus to maintain the temperature in said chamber substantially constant.

In the first aspect of the present invention, it is also preferred that said temperature control apparatus can supply the specimen with CO₂.

In the first aspect of the present invention, it is also preferred that said temperature control apparatus have humidification means.

According to a second aspect of the present invention, there is provided a microscope characterized by comprising an environment maintaining apparatus for microscope according to the first aspect of the present invention, an imaging lens that focuses parallel light transmitted through said transmissive portion of said environment maintaining apparatus for microscope to from an image, and observation means for observing an image of said specimen formed by said imaging lens.

According to the present invention, space and energy can be saved more as compared to prior arts.

### BRIEF DESCRIPTION OF THE DRAWINGS

FIG. 1 is a cross sectional view of an environment maintaining apparatus for microscope according to a first embodiment of the present invention.

FIG. 2 is a plan view of a microscope equipped with the environment maintaining apparatus for microscope shown in FIG. 1.

FIG. 3 is a schematic diagram showing a cross section taken along line A-A in FIG. 2.

FIG. 4 is a schematic diagram showing a cross section taken along line B-B in FIG. 2.

FIG. 5 is a schematic diagram showing a cross section taken along line C-C in FIG. 2.

FIG. 6 is a schematic diagram showing a cross section taken along line D-D in FIG. 2.

FIG. 7 schematic diagram showing a cross section of an environment maintaining apparatus for microscope according to a second embodiment of the present invention.

FIG. 8 is a schematic diagram showing an enlarged cross section of the environment maintaining apparatus for microscope shown in FIG. 7.

FIG. 9 is a control system diagram of the environment control system for microscope shown in FIG. 7.

### EMBODIMENT OF THE INVENTION

In the following, embodiments of the present invention will be described based on the drawings.

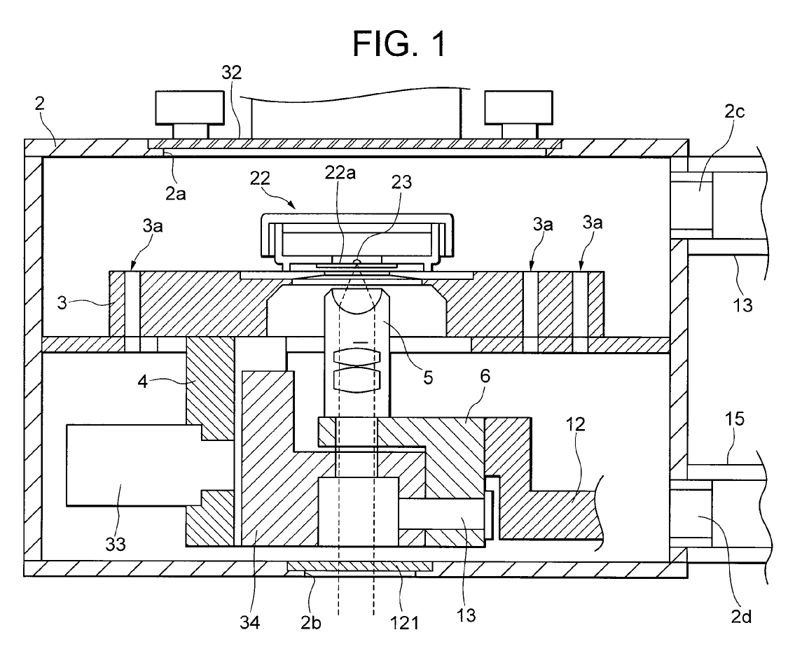

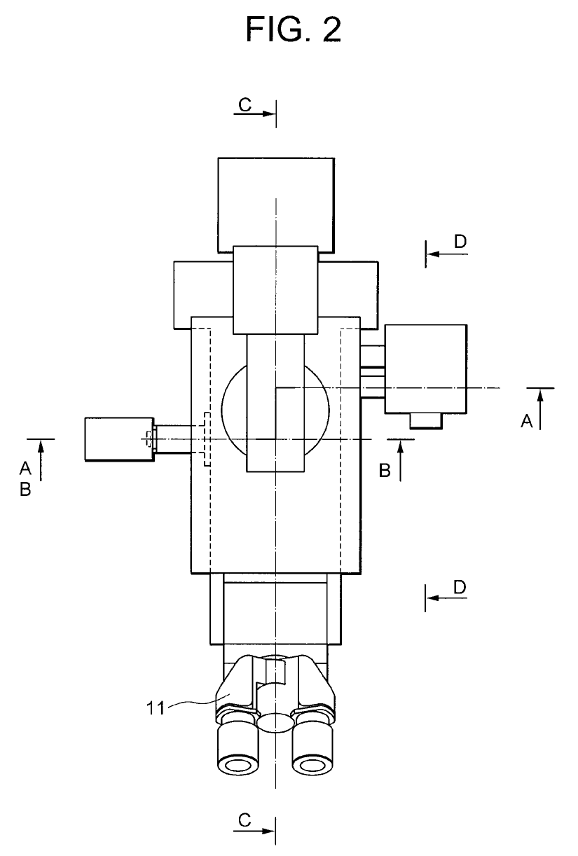

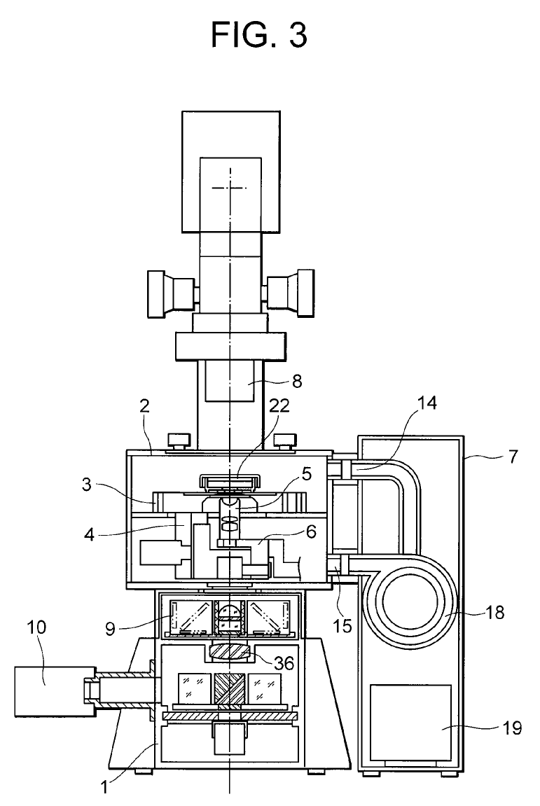

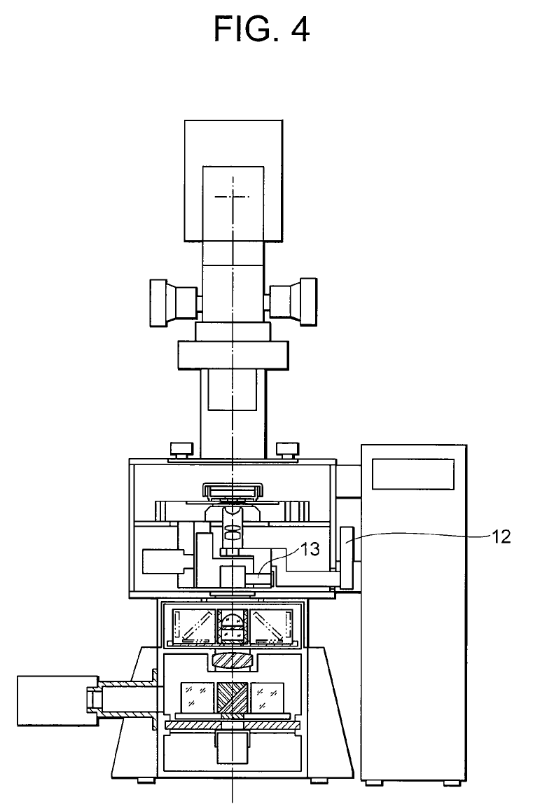

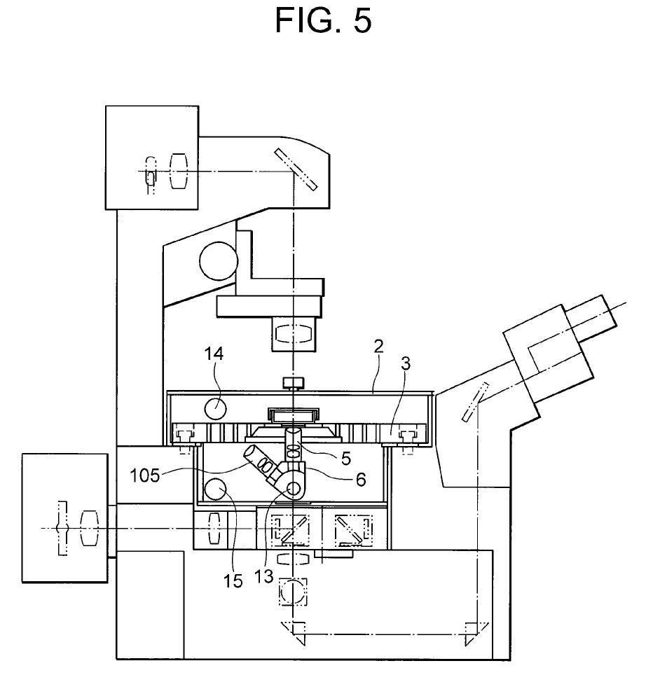

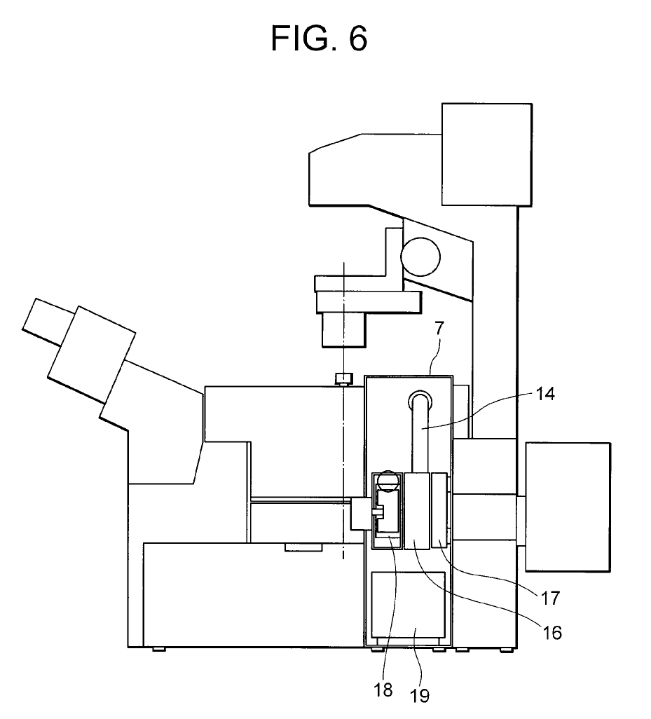

FIG. 1 is a cross sectional view of an environment maintaining apparatus for microscope according to a first embodiment of the present invention, FIG. 2 is a plan view of the environment maintaining apparatus for microscope shown in FIG. 1, FIG. 3 is a schematic diagram showing a cross section taken along line A-A in FIG. 2, FIG. 4 is a schematic diagram showing a cross section taken along line B-B in FIG. 2, FIG. 5 is a schematic diagram showing a cross section taken along line C-C in FIG. 2, and FIG. 6 is a schematic diagram showing a cross section taken along line D-D in FIG. 2.

First, a microscope equipped with the environment maintaining apparatus for microscope according to the first embodiment will be described.

As shown in FIGS. 2 to 5, the microscope has a microscope body 1, a transmission illumination apparatus 8, an epi-illumination apparatus 9 and an observation barrel 11. An imaging lens 36 is provided in the microscope body 1. On a side of the microscope body 1 is attached a CCD camera (observation means) 10 for observation of an image of a specimen. The transmission illumination apparatus 8 is disposed above the microscope body 1. The epi-fluorescent illumination apparatus 9 is disposed on the top surface of the microscope body 1. The observation barrel 11 is disposed obliquely above the microscope body 1.

Next, the environment maintaining apparatus for microscope according to the first embodiment will be described.

The environment maintaining apparatus for microscope is disposed on the epi-fluorescent illumination apparatus 9.

As shown in FIG. 1, an opening 2a is provided on the top surface of a first chamber 2, and an opening 2b is provided on the bottom surface of it. The first chamber 2 is a dark box made of a metal or resin that blocks light coming from the outside. The opening 2a is closed by a lid 32 made of a plane parallel glass plate having a knob. The opening 2b is closed by a plane parallel glass plate 121. The opening 2b and the plane parallel glass plate 121 constitute a first transmissive portion (transmissive portion). The opening 2a and the lid 32 constitute a second transmissive portion. The second transmissive portion allows transmission illumination for a specimen 23 on a stage 3, which will be described later. The second transmissive portion can be covered with a light blocking lid (not shown) or a shutter (not shown). An intake port 2c and an exhaust port 2d are provided on a side of the first chamber 2.

A stage 3 is housed in the first chamber 2. Holes 3a are formed on the stage 3 so as to allow airflow from the upper side to the lower side of the stage 3. A culture vessel (or a specimen case) 22 for culturing a specimen 23 is placed on the stage 3. The culture vessel 22 has a transmissive portion (a transmissive portion on the specimen case) 22a that transmits light from the specimen 23.

Below the stage 3 are provided a focusing apparatus 4, a revolver holding portion 34, a revolver 6 and two objective lenses 5, 105.

The focusing apparatus 4 is fixed on the stage 3. The focusing apparatus 4 has a motor 33.

The revolver holding portion 34 is supported on the focusing apparatus 4 in such a way as to be movable along the direction of the optical axis of the objective lens 5. The revolver holding portion 34 is moved along the optical axis direction by driving force of the motor 33. On this occasion, driving of the motor 33 is controlled by a control circuit that is not shown in the drawings.

The revolver 6 are rotatably mounted on a revolver holding portion 34 by a rotation shaft 13. One end of a lens changing lever 12 is attached to the revolver 6. The other end of the lens changing lever 12 extends to the exterior of the first chamber 2.

The objective lenses 5, 105 are mounted on the revolver 6. The objective lenses 5, 105 move along the optical axis direction with the revolver holding portion 34.

The objective lenses 5, 105 can be changed over by manipulating the lens changing lever 12 from the exterior of the first chamber 2.

As shown in FIG. 3, to the first chamber 2 is attached a circulation type temperature control apparatus 7. An intake tube 14 thereof is connected to the intake port 2c of the first chamber 2, and an exhaust tube 15 is connected to the exhaust port 2d of the first chamber 2. The temperature of the air in the interior of the first chamber 2 is adjusted to 37 degrees Celsius by the Peltier heating and cooling device 16 of the temperature control apparatus 7. The air in the first chamber 2 is circulated by a rotary fan 18 of the temperature control apparatus 7. The heat exchange performance of the heat exchange portion of the Peltier heating and cooling device 16 is maintained by the heating and cooling fan 17 that can supply/exhaust air from/to the exterior of the temperature control apparatus 7.

According to this embodiment, since only the stage 3, the focusing apparatus 4, the revolver holding portion 34, the revolver 6 and the objective lenses 5, 105 are housed in the first chamber 2, the environment maintaining apparatus for microscope can be made compact and space can be saved as compared to conventional apparatuses in which entire microscope is housed.

Furthermore, only the environment inside the first chamber 2 needs to be maintained, the energy needed to maintain the environment may be smaller as compared to conventional apparatuses in which the environment around the microscope is also maintained. Thus, energy can be saved.

Still further, even when, for example, the distance between the objective lens 5, 105 and the imaging lens 36 increases due to thermal expansion of the microscope caused by an increase in the ambient temperature, the apparatus is hard to be affected thereby, since the objective lens 5, 105 changes divergent light from the specimen into parallel beams.

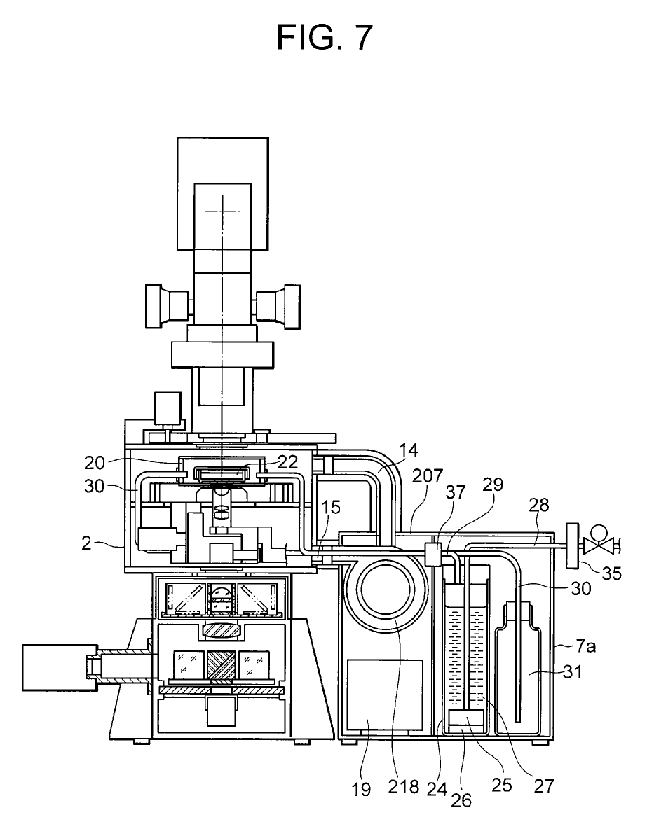

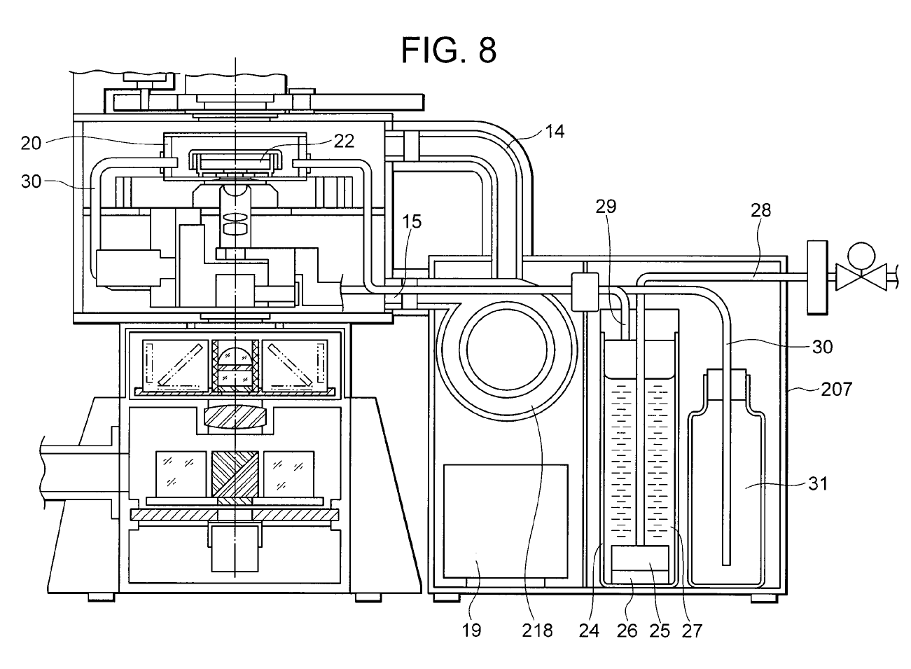

FIG. 7 is a schematic diagram showing a cross section of an environment maintaining apparatus according to a second embodiment of the present invention, and FIG. 8 is a schematic diagram showing an enlarged cross section of the environment maintaining apparatus for microscope shown in FIG. 7.

The portions same as those in the first embodiment will be denoted by the same reference numerals to omit redundant descriptions thereof. In the following, only different portions of significance will be described.

In the second embodiment, a second chamber 20 that houses a specimen is provided in the first chamber 2 in order to maintain the concentration of humidified CO₂ to a specific ratio in addition to control the ambient temperature of the specimen 23.

The temperature control apparatus 207 has a water tank (humidification means) 24 for humidification in addition to temperature control. Mixed air with a CO₂ concentration of 5% is supplied to the water tank 24 through a tube 28, and the mixed air is discharged into distilled water 27 through a foaming cylinder 25 provided at the exit of the tube 28, whereby humidification is achieved. In addition, since a heater 26 is provided on the bottom of the water tank 24 to maintain the temperature of the distilled water 27 at 37 degrees Celsius, the temperature environment in the interior of the second chamber 20 is not affected. The above described mixed air is supplied to the second chamber 20 through a tube 29 that passes through a rotary fan 218. The mixed air exhausted from the second chamber 20 is introduced to a bottle 31 through a tube 30, whereby condensed water is collected in the bottle 31.

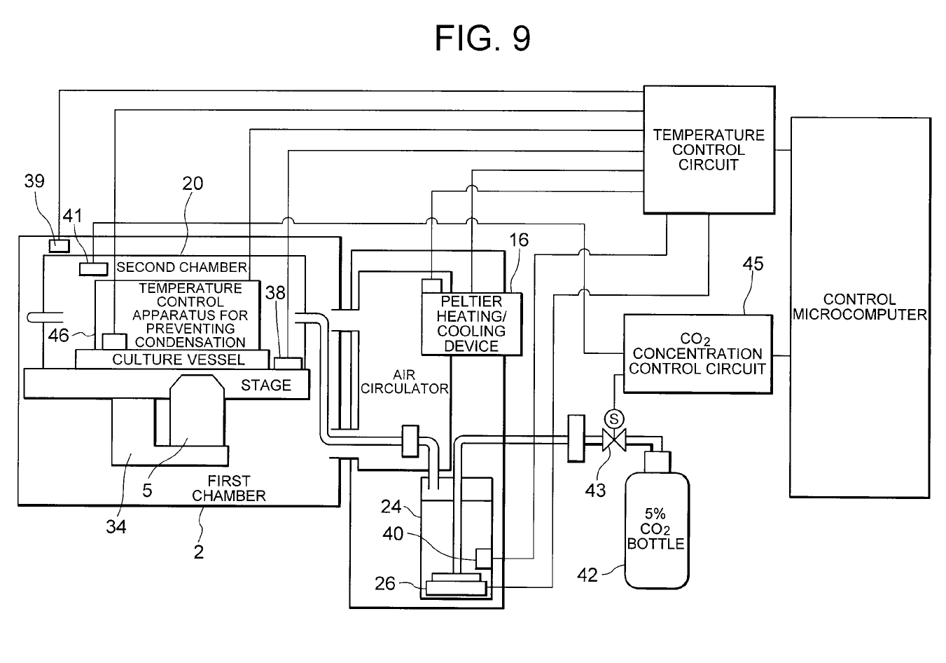

FIG. 9 is a diagram of the control system of the environment control apparatus for microscope shown in FIG. 7.

Next, environment control will be described.

The temperature and the CO₂ concentration is controlled by a control microcomputer in the following manner.

Supply of the mixed air from a bottle 42 is controlled in such a way that the temperature inside the first chamber 2, the second chamber 20 and the water tank 24 is maintained at 37 degrees Celsius and that the CO₂ concentration in the second chamber 20 is maintained at 5%.

The temperature in the first chamber 2 is monitored by a temperature sensor 38 provided in the second chamber 20, and the temperature is controlled by the Peltier heating and cooling device 16 so that the temperature of the specimen 23 becomes a prescribed temperature of 37 degrees Celsius. The temperature in the second chamber 20 is monitored by a temperature sensor 39 and controlled so that the air in the second chamber 20 is prevented from being heated or cooled excessively.

The temperature of the mixed air is monitored by a temperature sensor 40 provided in the water tank 24 and maintained at a prescribed temperature of 37 degrees Celsius. The CO₂ concentration is monitored by a CO₂ sensor 41 provided in the second chamber 20, and an electromagnetic valve 43 of the CO₂ bottle 42 is opened/closed by a CO₂ concentration control circuit 45 so that the CO₂ concentration in the second chamber 20 is maintained at 5%.

In the second chamber 20 is also provided a temperature control apparatus 46 for preventing condensation to prevent water condensation from occurring in the culture vessel.

According to the second embodiment, the temperature, the CO₂ concentration, the humidity and the focus position of the observed image can be maintained constant, and defocus will not occur. Therefore, it is possible to observe cultured cells for a long time.

1. An environment maintaining apparatus for microscope characterized by comprising:
a stage that supports a specimen;
an objective lens that changes light from the specimen on said stage into parallel light;
moving means attached to said stage for allowing said objective lens to move along the direction of its optical axis;
a chamber that houses said stage, said objective lens and said moving means to maintain environment; and
a transmissive portion provided on said chamber to transmit said parallel light to the exterior.

2. The environment maintaining apparatus for microscope according to claim 1, characterized by comprising a specimen case placed on said stage to store said specimen and a specimen case transmissive portion provided on the specimen case to transmit light from said specimen.

3. The environment maintaining apparatus for microscope according to claim 1, characterized by comprising a temperature control apparatus to maintain the temperature in said chamber substantially constant.

4. The environment maintaining apparatus for microscope according to claim 3, characterized in that said temperature control apparatus can supply the specimen with CO₂.

5. The environment maintaining apparatus for microscope according to claim 3, characterized in that said temperature control apparatus has humidification means.

6. The environment maintaining apparatus for microscope according to claim 1, characterized in that said chamber is a dark box that is made of a metal or resin that blocks light from outside.

7. The environment maintaining apparatus for microscope according to claim 1, characterized in that said chamber is provided with a second transmissive portion that can perform transmission illumination for said specimen on said stage.

8. The environment maintaining apparatus for microscope according to claim 7, characterized in that said second transmissive portion is provided with a lid or shutter for blocking light.

9. A microscope characterized by comprising:
the environment maintaining apparatus for microscope according to claim 1;
an imaging lens that focuses parallel light transmitted through said transmissive portion of said environment maintaining apparatus for microscope to form an image; and
observation means for observing an image of said specimen formed by said imaging lens.

10. A microscope characterized by comprising the environment maintaining apparatus for microscope according to claim 1, wherein said stage has a mechanism that moves the specimen in X and Y directions.

11. An environment maintaining apparatus for microscope characterized by comprising:
a stage that supports a specimen;
an objective lens that changes light from the specimen on said stage into parallel light;
moving means attached to said stage for allowing said specimen to move along the direction of the optical axis of the objective lens;
a chamber that houses said stage, said objective lens and said moving means to maintain environment; and
a transmissive portion provided on said chamber to transmit said parallel light to the exterior.
